(19) United States
(12) Patent Application Publication
(10) Pub. No.: US 2004/0094718 A1
(43) Pub. Date: May 20, 2004

(54) Radiation converter and method for the production thereof

(76) Inventors: Manfred Fuchs, Nurnberg (DE); Peter Hackenschmied, Nurnberg (DE); Erich Hell, Gingen (DE); Detlef Mattern, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/472,306

(22) PCT Filed: Mar. 22, 2002
(86) PCT No.: PCT/DE02/01056

(30) Foreign Application Priority Data
Apr. 4, 2001 (DE) 101 16 803.9

(51) Int. Cl. G01T 1/105

(52) U.S. Cl. 250/362

(57) ABSTRACT

The invention relates to a radiation converter, wherein a fluorescent layer formed by needle-shaped crystals (3) is applied on a substrate (1). In order to provide a radiation converter with improved light conducting properties that can be easily produced, a colorant (4) is contained in the crystals (3).

The invention concerns a radiation converter according to the preamble of claim 1. Furthermore, it concerns a method to produce such a radiation converter according to the preamble of claim 8.

Radiation converters apply in imaging medical diagnostics. They are employed as intensifier films in x-ray intensifiers, x-ray detectors, and x-ray film exposures, as storage luminophore image systems, and in cameras. In such radiation converters, high-energy radiation is absorbed in a scintillator layer or, respectively, luminophore layer and converted into light or stored as an electron/hole pair. The luminescence light formed in the luminophore due to the absorption of high-energy quanta also spreads laterally to a certain extent, whereby this effect increases with the layer thickness of the luminophore layer. The lateral light-spreading effects a degradation of the modulation transfer function MTF of the imaging system or, respectively, limits the resolution capabilities. Therefore a channelization of the light, i.e. an extensive prevention of the lateral light spreading, is to be sought. This effect has an especially strong influence in storage luminophore systems, because the stimulation light to excite the electron/hole pairs and the emission light that is formed are beamed or, respectively, are observed on the same axis. In addition, refer to EP 1 065 527 A2.

A radiation converter according to the species is, for example, known from EP 0 215 699 A1 or DE 44 33 132 A1. A luminophore layer formed from needle-shaped crystals is thereby mounted on a substrate produced, for example, from aluminum. The luminophore layer is produced from a doped alkali halogenide. To improve the light-conductive properties, it is known to introduce a colorant in the intervening space between the needle-shaped crystals.

In a disadvantageous manner, the colorants used in the practice have not proven to be especially stable with respect to x-ray radiation. The colorants are dissolved in a solvent applied to the luminophore layer. The solvent undesirably etches the luminophore layer. In a further method step ensuing after the application of the colorant, the colorant layer applied to the surface of the luminophore layer must again be removed. The production of the known radiation converter is complex.

The object of the invention is to remedy the disadvantages of the prior art. In particular, a radiation converter with good light-conductive properties should be specified that can be produced as simply and cost-effectively as possible.

This object is achieved by the features of the claims 1 and 8. Useful developments ensue from the features of the claims 2 through 7 and 111 through 19.

According to the requirements of the invention, it is provided that a dye is absorbed into the crystals. Surprisingly, such a radiation converter exhibits excellent light-conductive properties. An undesired lateral spreading of the scintillator light is almost completely suppressed. It is further surprising that the incorporation of colorants into the crystal lattice does not negatively influence the scintillation properties. The inventive radiation converter can be simply produced, in that, for example, an appropriate colorant is simultaneously vaporized with the luminophore. According to an advantageous development, the colorant is concentrated in the crystal junctions. A particularly high output in luminescent light can thereby be achieved.

The colorant can be a halogenide. Appropriately, the colorant can comprise one of the following metals: Ti, Co, Zr, V, Mn, Fe, Mo, Ta, Nb, Pd, In, Sn, Pt, W. The halogenide is selected in a preferable manner from the following group: TiBr₃, CoCl₂, ZrBr₃, ZrI₂, TiI₄, Vcl₄ [sic], InI, PdBr₂, PtCl₄, MoCl₄, TaI₅, WCl₄, WBr₅, MoBr₃, TaBr₅, TaCl₅, WCl₄, TiI₄, PdCl₂, FeCl₃, MnI₂, MoCl₃, NbBr₅, MoBr₂, SnI₄, MnCl₂, MnBr₂. According to a further development feature, the luminophore can be one a alkali halogenide selected from the following group: RbCl, RbI, RbBr, CsCl, CsJ, CsBr. The substrate can be produced from glass, aluminum, or stainless steel. The previously cited compounds have proven to be particularly appropriate for the production of a radiation converter according to the present invention.

According to the method-oriented requirements of the invention, it is provided that a colorant and/or a substance that, with a metal, reacts to form a colorant is/are vaporized during the vaporization of the luminophore. The method can be implemented simply and cost-effectively.

Due to the advantageous developments of the method, reference is made to the embodiments above which are correspondingly applicable to the method.

According to a method variant, a mixture produced from the luminophore and the colorant is vaporized from a common vaporization source. In this case, the container to accept the mixture is appropriately produced from an inert material.

According to a further variant of the method, a further mixture produced from the luminophore, the metal, and the substance is vaporized. The substance is appropriately selected from the following group: NaCl, NaBr, TiBr, SmBr2, EuBr₂, TlI, GaBr, EuCl₂. The metal can be selected from the following group: Ti, Co, V, Mn, Fe, Mo, Ta, Nb, Pd, In, Sn, Pt, W. In the melting of the luminophore, it thereby leads to a reaction between the metal and substance, in which the colorant is formed. The metal can be added to the mixture in the form of a powder. However, it is also possible to use a container produced from the metal in which the luminophore treated with the substance is accepted. Furthermore, it is also possible to guide a vapor comprising the luminophore and the substance over a surface produced from the metal, and subsequently to precipitate it on the substrate.

According to a further method variant, it is also possible to vaporize the colorant and the luminophore from separate vaporization sources. This enables a particularly precise calibration of the colorant contents in the crystals. Furthermore, it is possible to produce a colorant layer on the substrate before the precipitation of the luminophore. Furthermore, the vaporization source comprising the colorant can be closed prior to the vaporization source comprising the luminophore. Such a methodology enables that the surface of the crystal facing the light output comprises barely any colorant. A particularly high yield in luminescence light can be achieved. The modulation transfer function MTF is clearly improved in this case.

It has proven to be particularly advantageous to temper the luminophore layer at a temperature in the range of 100 to 300° C. The tempering effects a migration of the colorant to the crystal borders. Due to this, the colorant concentrates in the crystal borders. A lateral light spreading is particularly effectively suppressed. The output of the luminescence light in the direction of the c-axis of the needle-shaped crystals is drastically improved. Furthermore, it has shown that the tempering counteracts a recrystallization of the luminophore layer.

Exemplary embodiments of the invention are subsequently more closely explained using the drawings. Thereby shown are:

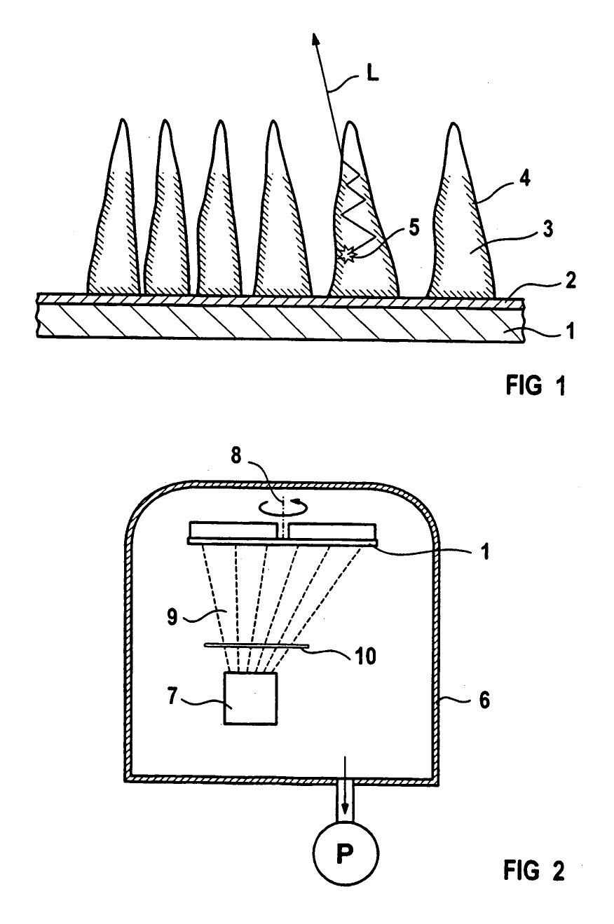

FIG. 1 a schematic cross-section view of a radiation converter,

FIG. 2 a schematic cross-section view of a vapor deposition system,

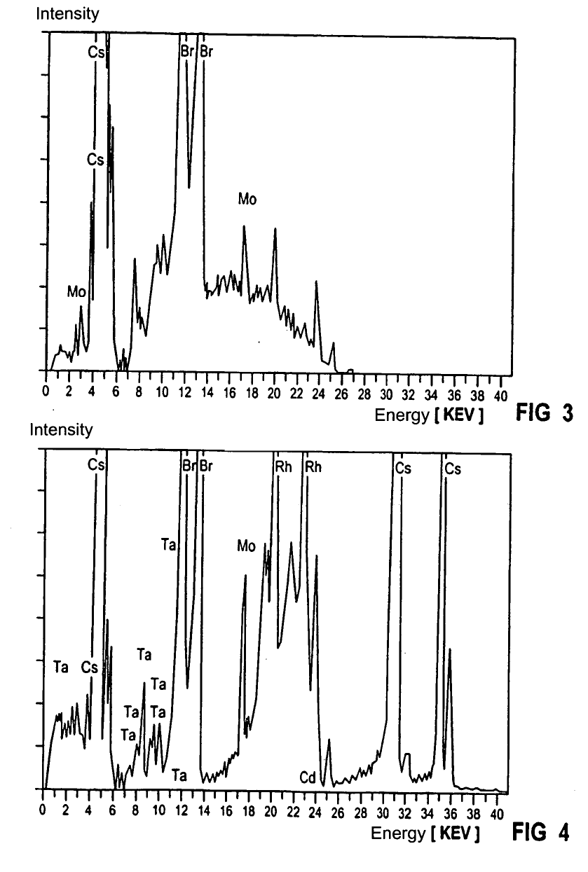

FIG. 3 a first x-ray fluorescence analysis and

FIG. 4 a second x-ray fluorescence analysis

A radiation converter is schematically shown in cross section in FIG. 1, in which a colorant layer 2 is applied to a substrate 1 produced from aluminum. Needle-shaped crystals are precipitated on the colorant layer 2 whose c-axis primarily extends perpendicular to the surface of the substrate 1. The crystals 3 comprise a concentration of colorant in the region of their crystal edges. Only in the region of the points of the needles is such a concentration of colorants 4 not present.

The function of the concentration of colorant 4 at the crystal borders is as follows: upon excitation of a luminophore center (designated as 5) with electromagnetic radiation, appropriate wavelengths form luminescence light L. This is, insofar as it spreads laterally in the crystal, reflected in the grain boundary enriched with colorant 4. The radiation of the reflected light is designated as L. The reflected luminescence light is uncoupled from the luminophore layer substantially perpendicular to the substrate surface.

A vapor deposition system to implement the inventive method is schematically shown in cross-section in FIG. 2. Located in a vacuum container 6 is a vapor deposition source 7 that is arranged opposite a substrate 1 that preferably rotated around an axis 8. The vapor deposition source 7 generates a vapor deposition jet 9 that is centered on the substrate 1.

The vapor deposition source 7 can, for example, comprise a vaporization boat made of molybdenum, in which is filled CsBr powder with 5% EuBr₂ doping. Furthermore, a grid or sheet 10 produced from, for example, tantalum is applied. The vapor escaping from the vaporization boat is channeled by the tantalum grid 11 [sic] or directed along the tantalum sheet. The vapor thereby absorbs metal. The crystals precipitated on the substrate 1 comprise TaBr₅ and MoBr₃. The crystals are colored green. The vaporization of the luminophore produced from CsB:EuBr₂ ensues appropriately given a temperature of 630 to 720° C. The grid 10 produced from the tantalum is heated to the respectively selected vaporization temperature.

Further exemplary embodiments for the implementation of the method:

190 g CsBr powder with 5% EuBr₂ doping are heated to 690° C. in a vaporization boat made of molybdenum. A baffle made of tantalum, which is likewise heated to 690° C., is applied over the vaporization boat. After complete vaporization of the luminophore, the crystals precipitated on the substrate 1 exhibit a dark green coloration. The coloration is ascribed to MoBr₂ and TaBr₅. FIG. 3 shows an x-ray fluorescence analysis of a luminophore layer produced in such a way.

155 g CsBr powder with 0.7% EuCl₂ doping are heated to 680° C. in a vaporization boat made from molybdenum. A baffle made of tantalum, which is likewise heated to 680° C., is applied over the vaporization boat. After complete vaporization of the luminophore, the crystals exhibit a yellow coloration.

170 g CsBr powder with 3.8% EuCl₂ doping are heated to roughly 700° C. in a vaporization boat made from molybdenum. A baffle made of tantalum, which is likewise heated to roughly 700° C., is applied over the vaporization boat. After complete vaporization of the luminophore, the crystals exhibit a brownish coloration.

170 g CsBr powder with 5.5% EuCl₂ doping are heated to roughly 700° C. in a vaporization boat made from molybdenum. A baffle made of tantalum, which is likewise heated to roughly 700° C., is applied over the vaporization boat. After complete vaporization of the luminophore, the crystals exhibit a brown coloration. It can detected from the x-ray fluorescence analysis evident from FIG. 4 of a luminophore layer produced in such a way that Mo and Ta are comprised therein, which are responsible for the coloration.

An amount of 100 to 1000 g CsBr powder with 0.1 to 10% EuCl₂, together with 0.1 to 100 g iron powder or manganese powder, are heated to 650 to 850° C. in a crucible produced from aluminum oxide or carbon. After complete vaporization of the luminophore, the crystals exhibit a red coloration. The produced luminophore layer is subsequently tempered at a temperature of 100 to 300° C. for a plurality of hours.

100 to 1000 g CsBr powder with 0.1 to 10% EuBr₂, together with 0.1 to 100 g zirconium powder or titanium powder, are heated in an inert crucible produced from aluminum oxide or carbon. After complete vaporization of the luminophore, the crystals exhibit a blue coloration. The produced luminophore layer is subsequently tempered at a temperature of 100 to 300° C. for a plurality of hours.

100 to 1000 g CsBr powder with 0.1 to 10% EuCl₂ are heated to 650 to 800° C. in a vaporization boat produced from cobalt. After complete vaporization of the luminophore, the crystals exhibit a blue coloration. The produced luminophore layer is subsequently tempered at a temperature of 100 to 300° C. for a plurality of hours.

1. Radiation converter, whereby a luminophore formed from needle-shaped crystals (3) is applied to a substrate (1), characterized in that a colorant (4) is absorbed into the crystals.

2. Radiation converter according to claim 1, whereby the colorant (4) is concentrated in the region of the crystal edges.

3. Radiation converter according to one of the preceding claims, whereby the colorant (4) is a halogenide.

4. Radiation converter according to any of the preceding claims, whereby the colorant (4) comprises one of the following metals: Ti, Co, Zr, V, Mn, Fe, Mo, Ta, Nb, Pd, In, Sn, Pt, W.

5. Radiation converter according to claim 3 or 4, whereby the halogenide is selected from the following group: TiBr₃, CoCl₂, ZrBr₃, ZrI₂, TiI₄, Vcl₄, InI, PdBr₂, PtCl₄, MoCl₄, TaI₅, WCl₄, WBr₅, MoBr₃, TaBr₅, TaCl₅, WI₄, TiI₄, PdCl₂, FeCl₃, MnI₂, MoCl₃, NbBr₅, MoBr₂, SnI₄, MnCl₂, MnBr₂.

6. Radiation converter according to any of the preceding claims, whereby the luminophore is an alkali halogenide selected from the following group: RbCl, RbI, RbBr, CsCl, CsJ, CsBr.

7. Radiation converter according to any of the preceding claims, whereby the substrate (1) is produced from glass, aluminum, or stainless steel.

8. Method to produce a radiation converter according to the preceding claims, whereby a luminophore is vaporized in a vapor deposition system and precipitated onto a substrate (1) in the form of needle-shaped crystals (3), characterized in that a colorant (4) and/or a substance reacting with a metal to create a colorant (4) is/are vaporized during the vaporization of the luminophore.

9. Method according to claim 8, whereby the colorant (4) is a halogenide.

10. Method according to claim 8 or 9, whereby the colorant (4) comprises one of the following metals: Ti, Co, Zr, V, Mn, Fe, Mo, Ta, Nb, Pd, In, Sn, Pt, W.

11. Method according to claim 9 or 10, whereby the halogenide is selected from the following group: TiBr₃, CoCl₂, ZrBr₃, ZrI₂, TiI₄, Vcl₄, InI, PdBr₂, PtCl₄, MoCl₄, TaI₅, WCl₄, WBr₅, MoBr₃, TaBr₅, TaCl₅, WI₄, TiI₄, PdCl₂, FeCl₃, MnI₂, MoCl₃, NbBr₅, MoBr₂, SnI₄, MnCl₂, MnBr₂.

12. Method according to any claims 9 through 11, whereby the luminophore is an alkali halogenide selected from the following group: RbCl, RbI, RbBr, CsCl, CsJ, CsBr.

13. Method according to any of the claims 8 through 14, whereby a further mixture produced from the luminophore and the colorant (4) is vaporized from a common vaporization source (7).

14. Method according to any of the claims 8 through 13, whereby a further mixture produced from the luminophore, the metal, and the substance is vaporized.

15. Method according to any of the claims 8 through 14, whereby the substance is selected from the following group: NaCl, NaI, NaBr, TiBr, SmBr2, TlI, GaBr, EuCl₂.

16. Method according to any of the claims 8 through 15, whereby the metal is selected from the following group: Ti, Co, Zr, V, Mn, Fe, Mo, Ta, Nb, Pd, In, Sn, Pt, W.

17. Method according to any of the claims 8 through 16, whereby a vapor comprising the luminophore and the substance is directed over a surface made of the metal (11) and is finally precipitated onto the substrate (1).

18. Method according to any of the claims 8 through 17, whereby the colorant (4) and the luminophore are vaporized from separate vaporization sources.

19. Method according to any of the claims 8 through 17, whereby the luminophore layer is tempered at a temperature in the range of 100 to 300° C.
